(19) United States
(12) Patent Application Publication
(10) Pub. No.: US 2010/0051434 A1
(43) Pub. Date: Mar. 4, 2010

(54) KEYPAD ASSEMBLY AND ELECTRONIC DEVICE USING THE SAME

(75) Inventor: CHIA-SHIEN LIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/337,749

(22) Filed: Dec. 18, 2008

(30) Foreign Application Priority Data
Aug. 27, 2008 (CN) 200810304239.2

(51) Int. Cl. H01H 13/70

(52) U.S. Cl. 200/5 A

(57) ABSTRACT

An exemplary keypad assembly includes a printed circuit board (PCB) including a plurality of fixed contact points, an elastic member disposed on the printed circuit board; a plurality of metallic domes fixed to the elastic member between the printed circuit board and the elastic member. Each of the metallic domes corresponds to each of the fixed contact points, and each metallic dome covers each fixed contact point. The keypad assembly has a thin configuration due to a combination configuration of the typical metallic dome sheet and the elastic member.

### BACKGROUND

1. Technical Field

The present disclosure relates to keypad assemblies, and particularly to a keypad assembly for use in portable electronic device.

2. Description of the Related Art

With the development of wireless communication and information processing technologies, portable electronic devices, such as mobile telephones and personal digital assistants, are now in widespread use. These electronic devices typically have a keypad assembly as an input terminal.

One such keypad assembly for a given electronic device includes a keypad, a light guide plate, an elastic member, a metallic dome sheet, a plurality of metallic domes, and a printed circuit board (PCB). In use, when any one of key buttons of the keypad is pressed down, the key button is deformed accordingly. A bottom of the key button presses a corresponding metallic dome to touch a fixed contact point, so that an electronic signal is generated.

However, due to need for these various components, the typical keypad assembly is unduly bulky, complicated and therefore costly to manufacture.

What is needed, therefore, is a new keypad assembly and an electronic device using the keypad assembly to overcome the above-described shortcomings.

### BRIEF DESCRIPTION OF THE DRAWINGS

Many aspects of the present keypad assembly of an electronic device can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a schematic, partial, isometric view of an electronic device according to a first exemplary embodiment of the present disclosure.

FIG. 2 is a schematic, partial, side cross-sectional view of the electronic device of FIG. 1 taken along line TI-TI, thereof.

FIG. 3 is a schematic, partial, dissembled, side cross-sectional view of the electronic device according to a second exemplary embodiment of the present disclosure.

### DETAILED DESCRIPTION OF THE PREFERRED EMBODIMENTS

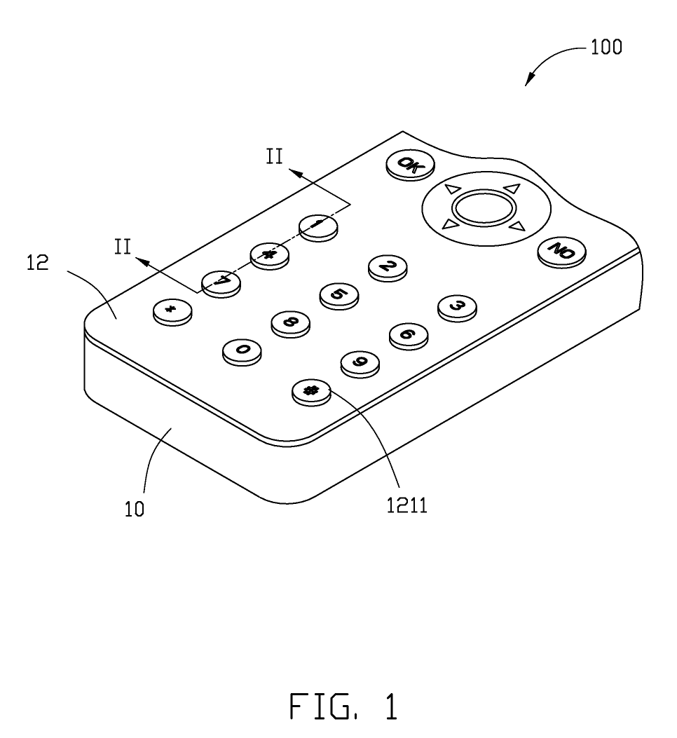

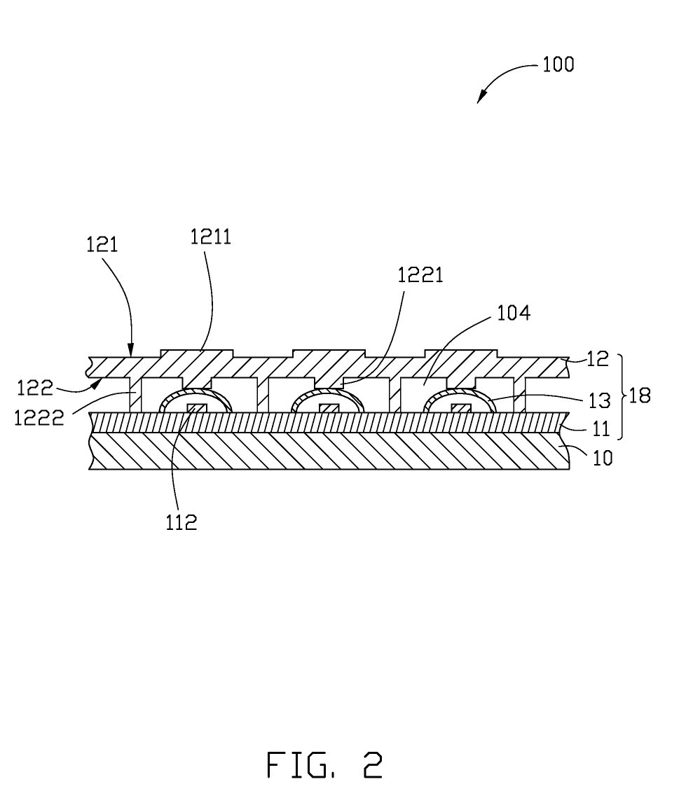

Referring to FIGS. 1 and 2, an electronic device 100 in accordance with a first exemplary embodiment includes a housing 10 and a keypad assembly 18. The housing 10 defines a chamber 104. The keypad assembly 18 is suitably assembled within the chamber 104 of the housing 10. The electronic device 100 may be a portable electronic device, such as the mobile phone, a personal digital handset, or the like.

Referring to FIG. 2, the keypad assembly 18 includes a PCB 11, an elastic member 12, and a plurality of metallic domes 13. The PCB 11 includes a plurality of fixed contact points 112 formed on a surface of the PCB 11. The elastic member 12 is arranged on the PCB 11. The elastic member 12 includes a first surface 121 and a second surface 122 opposite to the first surface 121. The second surface 122 faces the PCB 11. The elastic member 12 further includes a plurality of key button protrusions 1211 formed on the first surface 121, a plurality of pressing protrusions 1221 formed on the second surface 122, and a plurality of supporting columns 1222 extending downwardly from the second surface 122 toward the PCB 11. The key button protrusions 1211 respectively correspond to the pressing protrusions 1221, and are respectively located above the fixed contact points 112 of the PCB 11. The supporting columns 1222 are arranged between the pressing protrusions 1221. The metallic domes 13 are fixed to a free end of the pressing protrusions 1221 respectively between the elastic member 12 and the PCB 11. Each of the metallic domes 13 faces and covers the corresponding fixed contact points 112 of the PCB 11.

In this embodiment, the elastic member 12 is made of non-electrical conductive materials, such as rubber, for example. The elastic member 12 may be integrally formed by injection molding method in one embodiment. Each of the metallic domes 13 has a hemispherical shape. Each metallic dome 13 adheres to the corresponding free end of the pressing protrusion 1221. The metallic domes 13 have electrical conductive characteristic. The key button protrusions 1211 form a plurality of configurations (not labeled) in shape of letters, numerals and/or symbols.

When a user presses any one key button protrusion 1211, the pressing protrusion 1221 presses the corresponding metallic dome 13. The pressed metallic dome 13 comes in electrical contact with the corresponding fixed contact point 112 of the PCB 11, so that an electronic signal is generated. When the key button protrusion 1211 is released, the elastic member 12 and the metallic dome 13 return to their original states due to the elasticity of the elastic member 12 the metallic dome 13.

The keypad assembly 18 and the electronic device 100 can have a thin configuration due to a combination configuration of the typical metallic dome sheet and the elastic member. It should be pointed out that the supporting columns 1222 may be separate members fixed to the second surface 122 of the elastic member 12. The supporting columns 1222 are preferably made of solid materials without resilient capability, such as solid plastic. When any one of the metallic domes 13 are pressed, the supporting columns 122 may protect adjacent metallic domes 13.

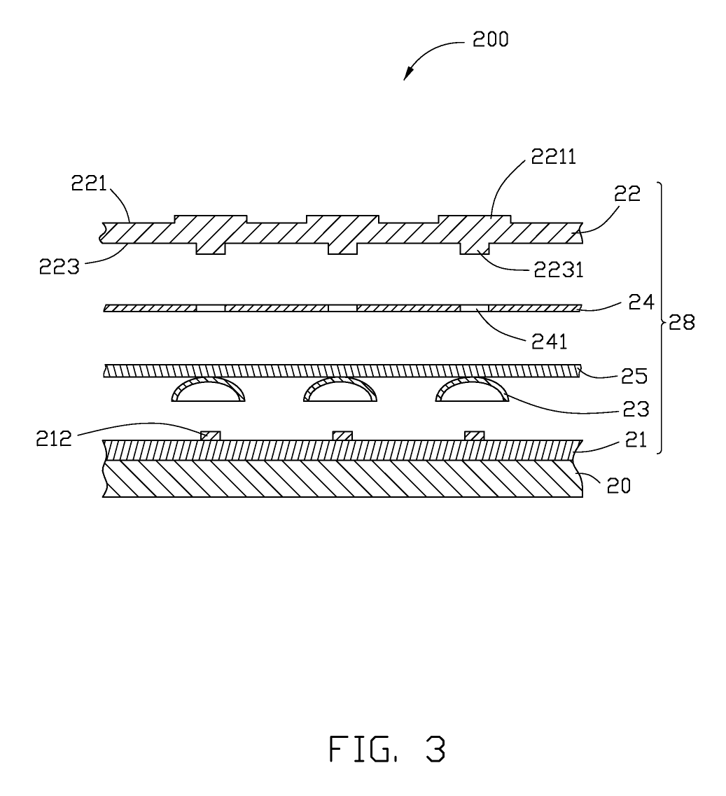

Referring to FIG. 3, an electronic device 200 in accordance with a second exemplary embodiment includes a housing 20, and a keypad assembly 28. The keypad assembly 28 includes a PCB 21, a plurality of metallic domes 23, and an elastic member 25. The keypad assembly 28 is similar as principle to the keypad assembly 18 of the first exemplary embodiment, except that the elastic member 25 is different from the elastic member 12 of the keypad assembly 18, and the keypad assembly 18 further includes a keypad 22 and a light guide plate 24.

The PCB 21 includes a plurality of fixed contact points 212 formed on an upper surface of the PCB 21. The elastic member 25 is a flat sheet. The metallic domes 23 are fixed to a bottom surface of the elastic member 25. The elastic member 25 with the metallic domes 23 is disposed on the PCB 21, and each of the metallic domes 23 faces and surrounds the corresponding fixed contact points 212 of the PCB 21. The light guide plate 24 defines a plurality of through holes 241 corresponding to the metallic domes 23 and the fixed contact points 212. The light guide plate 24 is positioned on the elastic member 25. The keypad 22 is a plate which includes a first surface 221 and a second surface 223 opposite to the first surface 221. The keypad 22 further includes a plurality of key button protrusions 2211 extending out from the first surface 221, and a plurality of pressing protrusions 2231 extending out from the second surface 223. Each key button protrusion 2211 corresponds to one pressing protrusion 2231, and all of the pressing protrusions 2231 pass through the corresponding through holes 241 of the light guide plate 24.

When a user presses down on any one of the key button protrusions 2211, the pressing protrusion 2231 presses the elastic sheet 25 and the corresponding metallic dome 23. The pressed metallic dome 23 comes in electrical contact with the corresponding fixed contact point 212 of the PCB 21, so that an electronic signal is generated. When the key button protrusion 2211 is released, the elastic member 25 and the metallic dome 23 return to their original states due to the elasticity of the elastic member 25 and the metallic domes 23.

The keypad assembly 28 and the electronic device 200 can have a thin configuration due to a combination configuration of the typical metallic dome sheet and the elastic member.

Finally, while the present disclosure has been described with reference to particular embodiments, the description is illustrative of the disclosure and is not to be construed as limiting the disclosure. Therefore, various modifications can be made to the embodiments by those skilled in the art without departing from the true spirit and scope of the disclosure as defined by the appended claims.

What is claimed is:

1. A keypad assembly comprising:
a printed circuit board comprising a plurality of fixed contact points formed thereon,
an elastic member disposed on the printed circuit board;
a plurality of metallic domes fixed to the elastic member and positioned between the printed circuit board and the elastic member, wherein each of the metallic domes corresponds to each of the plurality of fixed contact points, and each metallic domes covers each of the plurality of fixed contact points.

2. The keypad assembly of claim 1, wherein the elastic member comprises a first surface, a second surface opposite to the first surface, and a plurality of pressing protrusions formed on the second surface corresponding to the fixed contact points of the printed circuit board, the second surface facing the printed circuit board.

3. The keypad assembly of claim 2, wherein the elastic member further comprises a plurality of supporting columns extending out from the second surface thereof.

4. The keypad assembly of claim 2, wherein the elastic member further comprises a plurality of supporting columns fixed to the second surface thereof.

5. The keypad assembly of claim 4, wherein the supporting columns are made of solid plastic.

6. The keypad assembly of claim 2, wherein the elastic member further comprises a plurality of key button protrusions extending out from the first surface thereof corresponding to the fixed contact points of the printed circuit board.

7. The keypad assembly of claim 1, wherein the elastic member is made of rubber.

8. The keypad assembly of claim 1, further comprising a keypad, the keypad having a first surface, a second surface opposite to the first surface, a plurality of key button protrusions extending out from the first surface, and a plurality of pressing protrusions extending out from the second surface, the key button protrusions respectively correspond to the pressing protrusions.

9. The keypad assembly of claim 8, further comprising a light guide plate disposed between the keypad and the elastic member, the light guide plate defining a plurality of through holes corresponding to the pressing protrusions of the keypad for receiving the pressing protrusions correspondingly.

10. An electronic device comprising:
a housing defining a chamber, and
a keypad assembly fixed in the chamber, the keypad assembly comprising:
a printed circuit board comprising a plurality of fixed contact points formed thereon,
an elastic member disposed on the printed circuit board;
a plurality of metallic domes fixed to the elastic member and positioned between the printed circuit board and the elastic member, wherein each of the metallic domes corresponds to each of the plurality of fixed contact points, and each metallic domes covers each of the plurality of fixed contact points.

11. The electronic device of claim 10, wherein the elastic member comprises a first surface, a second surface opposite to the first surface, and a plurality of pressing protrusions formed on the second surface corresponding to the fixed contact points of the printed circuit board, the second surface facing the printed circuit board.

12. The electronic device of claim 11, wherein the elastic member further comprises a plurality of supporting columns extending out from the second surface thereof.

13. The electronic device of claim 11, wherein the elastic member further comprises a plurality of supporting columns fixed to the second surface thereof.

14. The electronic device of claim 13, wherein the supporting columns are made of solid plastic.

15. The electronic device of claim 11, wherein the elastic member further comprises a plurality of key button protrusions extending out from the first surface thereof corresponding to the fixed contact points of the printed circuit board.

16. The electronic device of claim 10, wherein the elastic member is made of rubber.

17. The electronic device of claim 10, further comprising a keypad, the keypad having a first surface, a second surface opposite to the first surface, a plurality of key button protrusions extending out from the first surface, and a plurality of pressing protrusions extending out from the second surface, the key button protrusions respectively correspond to the pressing protrusions.

18. The electronic device of claim 17, further comprising a light guide plate disposed between the keypad and the elastic member, the light guide plate defining a plurality of through holes corresponding to the pressing protrusions of the keypad for receiving the pressing protrusions correspondingly.
